(19) United States
(12) Patent Application Publication
(10) Pub. No.: US 2010/0070885 A1
(43) Pub. Date: Mar. 18, 2010

(54) Linking Avatar Profiles Within a Virtual Environment

(75) Inventors: Derek L. Bromenshenkel, Rochester, MN (US); Ryan K. Cradick, Oronoco, MN (US); Zachary A. Garbow, Rochester, MN (US); Daniel L. Hiebert, Pine Island, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 12/212,135

(22) Filed: Sep. 17, 2008

(51) Int. Cl. G06F 3/048

(52) U.S. Cl. 715/757

(57) ABSTRACT

Embodiments of the invention provide techniques for linking user profiles within an immersive virtual environment. In one embodiment, a group is dynamically formed based on one or more criteria, including interactions, movements, history, viewports, friends lists, and the like. Once the group is formed, a group profile may be generated by, e.g., aggregating the individual user profiles of the group members. The group profile may control the interaction of the group members with the virtual world, thus providing a uniform and consistent experience for all group members.

### BACKGROUND OF THE INVENTION

1. Field of the Invention

Embodiments of the invention relate to immersive virtual environments. More specifically, embodiments of the invention relate to dynamically linking user profiles within an immersive virtual environment.

2. Description of the Related Art

A virtual world is a simulated environment in which users may inhabit and interact with one another via avatars. Users may also interact with virtual objects and locations of the virtual world. An avatar generally provides a graphical representation of an individual within the virtual world environment. Avatars are usually presented to other users as two or three-dimensional graphical representations of humanoids. Frequently, virtual worlds allow for multiple users to enter and interact with one another. Virtual worlds provide an immersive environment as they typically appear similar to the real world, with real world rules such as gravity, topography, locomotion, real-time actions, and communication. Communication may be in the form of text messages sent between avatars, but may also include real-time voice communication.

Virtual worlds may be persistent. A persistent world provides an immersive environment (e.g., a fantasy setting used as a setting for a role-playing game) that is generally always available, and world events happen continually, regardless of the presence of a given avatar. Thus, unlike more conventional online games or multi-user environments, the plots and events continue to develop even while some of the players are not playing their characters.

### SUMMARY OF THE INVENTION

One embodiment of the invention includes a computer-implemented method. The method generally includes: receiving one or more characteristics of a plurality of avatars within a virtual world; determining, on the basis of the one or more characteristics, a group of avatars selected from the plurality of avatars; determining, based on personal preferences of members of the group of avatars, a shared set of preferences defining the interactions of the members of the group of avatars with the virtual world; and generating a group profile storing the common set of preferences.

Another embodiment of the invention includes a computer-readable storage medium containing a program, which when executed on a processor performs an operation. The operation may generally include: receiving one or more characteristics of a plurality of avatars within a virtual world; determining, on the basis of the one or more characteristics, a group of avatars selected from the plurality of avatars; determining, based on personal preferences of members of the group of avatars, a shared set of preferences defining the interactions of the members of the group of avatars with the virtual world; and generating a group profile storing the common set of preferences.

Still another embodiment of the invention includes a system having a processor and a memory containing a program, which when executed by the processor is configured to perform an operation. The operation may generally include: receiving one or more characteristics of a plurality of avatars within a virtual world; determining, on the basis of the one or more characteristics, a group of avatars selected from the plurality of avatars; determining, based on personal preferences of members of the group of avatars, a shared set of preferences defining the interactions of the members of the group of avatars with the virtual world; and generating a group profile storing the common set of preferences.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram that illustrates a client server view of computing environment, according to one embodiment of the invention.

FIG. 2 illustrates a user display for a user participating in a virtual world, according to one embodiment of the invention.

FIG. 3 is a flow diagram illustrating a method for determining a grouping of avatars within a virtual world, according to one embodiment of the invention.

FIG. 4 is a flow diagram illustrating a method for presenting a virtual world to a group of avatars, according to one embodiment of the invention.

FIG. 5 illustrates an exemplary group profile, according to one embodiment of the invention.

### DETAILED DESCRIPTION OF THE PREFERRED EMBODIMENTS

A virtual world is a simulated environment in which users may be represented by avatars. An avatar may be used to “travel” through locations of the virtual world, such as virtual streets, buildings, rooms, etc. While in a given location, an avatar may also be used to interact with virtual objects or other avatars present therein. Such virtual objects may represent objects found in the real world, such as a car, a house, a tree, etc. A user profile may specify preferences for interacting with the virtual world (hereinafter referred to as “user preferences”). For example, the user profile may specify user preferences for the visual presentation of the virtual world, such as lighting, colors, styles, etc. The user profile may also specify user preferences for sound presentation (i.e., speech, music, etc.), interactivity with virtual objects, physics rules within the virtual world, and the like.

In some situations, users may wish to interact with a virtual world as part of a group of avatars. For example, users may form a group in the virtual world to participate in games, to attend a business meeting, as part of a social club, etc. However, in such situations, the user preferences of the members of the group may differ, thus resulting in group members having different experiences within the virtual world. Such different experiences may cause difficulty and confusion within the group. For example, a group of avatars in a virtual store may not “see” virtual objects in the same way, thus leading to confusion in discussing any products included the store.

Embodiments of the invention provide techniques for linking user profiles within an immersive virtual environment (e.g., a three dimensional (3D) environment). In one embodiment, a group is dynamically formed based on one or more criteria, including interactions, movements, history, viewports, friends lists, and the like. Once the group is formed, a group profile may be generated by, e.g., aggregating the individual user profiles of the group members. The group profile may control the interaction of the group members with the virtual world, thus providing a uniform and consistent experience for all group members.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive and DVDs readable by a DVD player) on which information is permanently stored; and (ii) writable storage media (e.g., floppy disks within a diskette drive, a hard-disk drive or random-access memory) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

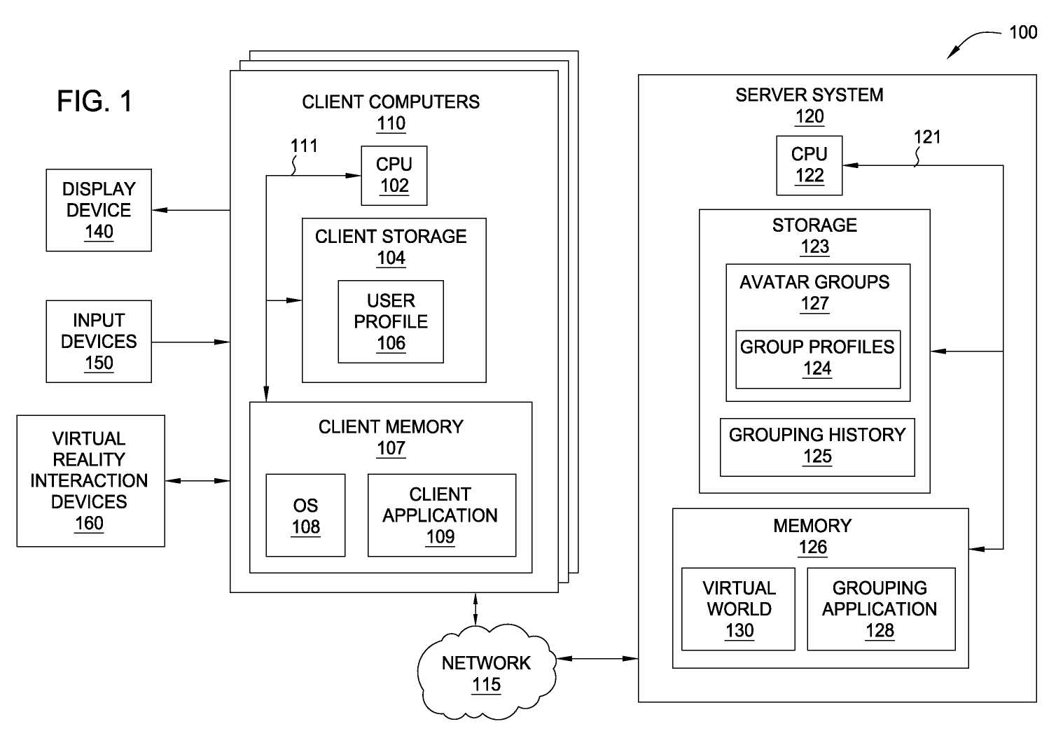

FIG. 1 is a block diagram that illustrates a client server view of computing environment 100, according to one embodiment of the invention. As shown, computing environment 100 includes client computers 110, network 115 and server system 120. In one embodiment, the computer systems illustrated in environment 100 may include existing computer systems, e.g., desktop computers, server computers, laptop computers, tablet computers, and the like. The computing environment 100 illustrated in FIG. 1, however, is merely an example of one computing environment. Embodiments of the present invention may be implemented using other environments, regardless of whether the computer systems are complex multi-user computing systems, such as a cluster of individual computers connected by a high-speed network, single-user workstations, or network appliances lacking non-volatile storage. Further, the software applications illustrated in FIG. 1 and described herein may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

As shown, each client computer 110 includes a central processing unit (CPU) 102, which obtains instructions and data via a bus 111 from client memory 107 and client storage 104. CPU 102 is a programmable logic device that performs all the instruction, logic, and mathematical processing in a computer. As shown, client storage 104 includes user profile 106, which is described further below. Client storage 104 may represent hard-disk drives, flash memory devices, optical media and the like. Client computer 110 is operably connected to the network 115.

Client memory 107 includes an operating system (OS) 108 and a client application 109. Operating system 108 is the software used for managing the operation of the client computer 110. Examples of OS 108 include UNIX, a version of the Microsoft Windows® operating system, and distributions of the Linux® operating system. (Note, Linux is a trademark of Linus Torvalds in the United States and other countries.)

In one embodiment, the client application 109 provides a software program that allows a user to connect to a virtual world 130, and once connected, to perform various user actions. Such actions may include exploring virtual locations, interacting with other avatars, and interacting with virtual objects. Further, the client application 109 may be configured to generate and display a visual representation of the user within the immersive environment, generally referred to as an avatar. The avatar of the user is generally visible to other users in the virtual world, and the user may view avatars representing the other users. The client application 109 may also be configured to generate and display the immersive environment to the user and to transmit the user's desired actions to the virtual world 130 on the server 120. Such a display may include content from the virtual world determined from the user's line of sight at any given time. For the user, the display may include the avatar of that user or may be a camera eye where the user sees the virtual world through the eyes of the avatar representing this user.

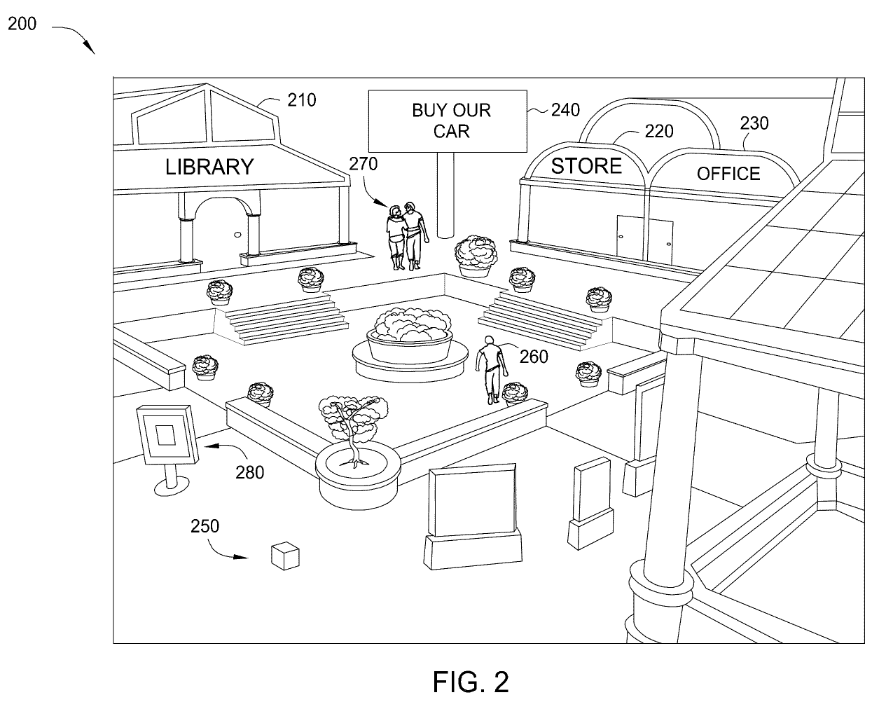

By way of example, FIG. 2 illustrates a user display 200 for a user participating in a virtual world, according to one embodiment of the invention. In this example, the user display 200 presents a “third-person” view, meaning the user is represented by an avatar 260 that is visible within the user display 200. As shown, user display 200 is displaying a view of a virtual plaza included in the virtual world 130. The user may interact with elements displayed in user display 200. For example, the user may interact with a box 250 by picking it up, opening it, etc. The user may also interact with a kiosk 280 by operating controls built into the kiosk 280, requesting information, etc. The user may also interact with a billboard 240 by looking at it, reading displayed text, etc. In addition, a user may interact with larger elements of the virtual world. For example, the user may be able to enter a store 220, an office 230, or a library 210. As used herein, the term “virtual objects” refers broadly to elements of a virtual world (e.g., box 250, store 220, etc.).

Referring again to FIG. 1, the user may view the virtual world using a display device 140, such as an LCD or CRT monitor display, and interact with the client application 109 using input devices 150. Further, in one embodiment, the user may interact with the client application 109 and the virtual world 130 using a variety of virtual reality interaction devices 160. For example, the user may don a set of virtual reality goggles that have a screen display for each lens. Further, the goggles could be equipped with motion sensors that cause the view of the virtual world presented to the user to move based on the head movements of the individual. As another example, the user could don a pair of gloves configured to translate motion and movement of the user's hands into avatar movements within the virtual reality environment. Of course, embodiments of the invention are not limited to these examples and one of ordinary skill in the art will readily recognize that the invention may be adapted for use with a variety of devices configured to present the virtual world to the user and to translate movement/motion or other actions of the user into actions performed by the avatar representing that user within the virtual world 130.

In one embodiment, client storage 104 may store a user profile 106. User profile 106 may be a data structure including data describing an individual user's preferences for interactions with virtual world 130. That is, the client application 109 may be configured to present the virtual world 130 according to the user preferences in the user profile 106. The user profile 106 may include preferences for sensory presentation of virtual world 130, such as visual presentation (e.g., preferred colors, line styles, etc.), auditory presentation (e.g., volume, sounds, music soundtrack, etc.), and the like. Further, user profile 106 may include preferences for interactivity with virtual objects of virtual world, such as allowing “driving” virtual cars, not allowing use of virtual weapons, etc. The user profile 106 may also include preferences for physics rules within the virtual world, such as allowing the user's avatar to “fly,” restricting “walking” or “running” movements to realistic speeds, allowing the avatar to pass through virtual walls, etc. Furthermore, the user profile 106 may include data describing the user's interests and activities. For example, the user profile 106 may include metadata describing the user's hobbies, attendance at entertainment events, participation in activities, searches for keywords, and the like.

In one embodiment, the server system 120 includes a CPU 122, which obtains instructions and data via a bus 121 from memory 126 and storage 123. The CPU 122 could be any processor adapted to support the methods of the invention. The memory 126 is any memory sufficiently large to hold the necessary programs and data structures. Memory 126 could be one or a combination of memory devices, including Random Access Memory, nonvolatile or backup memory, (e.g., programmable or Flash memories, read-only memories, etc.). In addition, memory 126 and storage 123 may be considered to include memory physically located elsewhere in a server 120, for example, on another computer coupled to the server 120 via bus 121. The server system 120 may be operably connected to the network 115, which generally represents any kind of data communications network. Accordingly, the network 115 may represent both local and wide area networks, including the Internet.

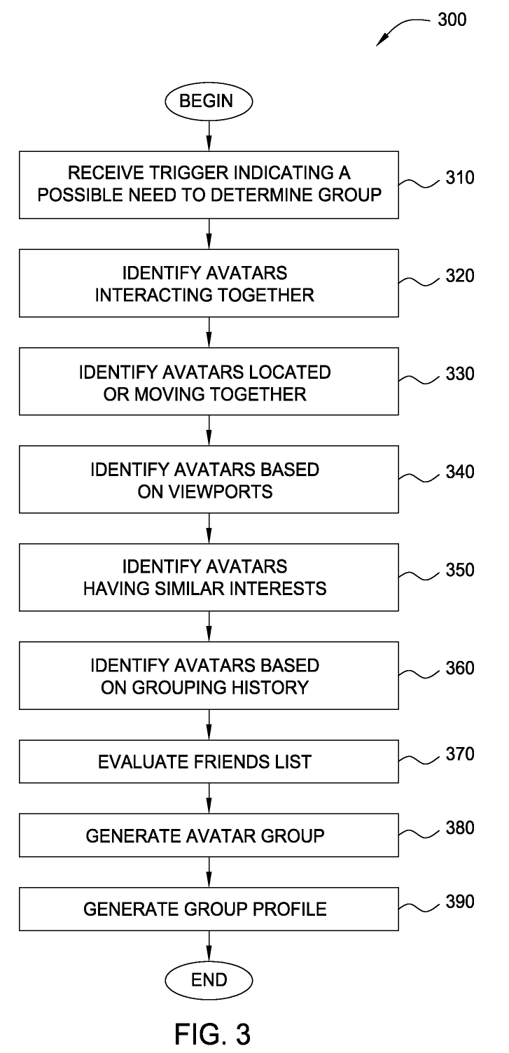

As shown, the memory 126 includes a virtual world 130 and a grouping application 128. In one embodiment, the virtual world 130 may be a software application that allows a user to explore and interact with an immersive environment. The grouping application 128 may be a software application configured to determine avatar groups within virtual world 130, for use in ensuring consistent virtual experiences for each avatar. In one embodiment, the grouping application 128 may be configured to determine avatar groups (e.g., avatar groups 127 included in storage 123) on the basis of one or more criteria, such interactions, movements, viewports, etc. The grouping of avatars into avatar groups is discussed in greater detail below with reference to FIG. 3.

As shown, the storage 123 may include avatar groups 127 and grouping history 125. Each avatar group 127 may include a group profile 124. In one embodiment, the grouping application 128 may be configured to generate a group profile 124 for each avatar group 127. For example, the grouping application 128 may generate a group profile 124 by combining the individual user profiles 106 of the members of the avatar group 127. The group profile 124 may represent, e.g., the least common preferences from the user profiles 106 of each member of the avatar group 127. Alternatively, the group profile 124 may be based on the user profile 106 of a specific member of the avatar group 127 (e.g., a designated group leader). The grouping history 125 may be a data structure storing historical data describing current and past instances of avatar groups 127.

FIG. 3 is a flow diagram illustrating a method 300 for determining a grouping of avatars within a virtual world, according to one embodiment of the invention. Persons skilled in the art will understand that, even though the method is described in conjunction with the system of FIG. 1, any system configured to perform the steps of the method 300, in any order, is within the scope of the present invention.

The method 300 begins at step 310, when a grouping application 128 receives a trigger indicating a need to determine an avatar group 127 within a virtual world 130. Such a trigger may include a user command to form a group (e.g., menu selection, toolbar selection, etc.), a scheduled group event, a situation or avatar action occurring within the virtual world (e.g., the presence of a given number of avatars in a space), and the like.

At step 320, the grouping application 128 may identify two or more avatars that are interacting together. Such interactions may include communicating with each other (e.g., text chat, voice chat, etc.), carrying out transactions (e.g., buying, selling, etc.), participating in the same games or sports, sharing a common task, and the like. At step 330, the grouping application 128 may identify two or more avatars that are located or moving together. For example, the grouping application 128 may identify avatars that are in the same location for a given time period, avatars that are moving from one point to another while being within a given proximity to each other, avatars that are moving from one point to another within a given time of each other, and the like. Further, the grouping application 128 may identify avatars that move together to multiple locations. In one embodiment, as the number of locations and movements shared by the avatars increases, the grouping application 128 may be more likely to determine a grouping for the avatars.

At step 340, the grouping application 128 may identify avatars based on their viewports, meaning the view of virtual world 130 displayed to the user of each avatar (i.e., the user display 200 shown in FIG. 2). For example, the grouping application 128 may identify avatars that are looking at each other for at least a minimum time, avatars that are looking in the same direction or at the same object (or sequence of objects) for a given time, and the like. At step 350, the grouping application 128 may identify avatars representing users that have similar interests (e.g., avatars representing users that interact with the same objects, participate in the same events or activities, perform similar searches, etc.). For example, the grouping application 128 may analyze metadata describing a user's interests to identify users having similar interests. Such metadata may be included in the user profiles 106 (e.g., located in each user's client computer 110).

At step 360, the grouping application 128 may identify avatars based on grouping history. For example, the grouping application 128 may be configured to identify avatars that have been part of the same (or similar) avatar groups 127 in the past. In one embodiment, the grouping application 128 may analyze the grouping history 125 included in storage 123. At step 370, the grouping application 128 may evaluate a friends list (e.g., a predefined list of the friends or acquaintances of the user). For example, the grouping application 128 may be configured to be more likely to group avatars if their users are included in each other's friends list.

At step 380, the grouping application 128 may generate a group of avatars (e.g., an avatar group 127 illustrated in FIG. 1). In one embodiment, the grouping application 128 may generate an avatar group 127 based on the results of steps 320-370 described above, with the results of each step being given specified degrees of importance. The grouping application 128 may then notify each user of being included in the avatar group 127. Further, the grouping application 128 may enable the user to approve or disapprove being added to the avatar group 127, or may enable the user to specify personal exceptions to the group profile 124 for the avatar group 127. For example, the grouping application 128 may send the user an electronic message (an email, text message, instant message, etc.) communicating that the user may be added to a new avatar group 127, and may include a link to an interface where the user may approve the user's membership in the avatar group 127. The linked interface may also be configured to enable the user to terminate membership in the avatar group at a later time. Furthermore, the grouping application 128 may update the grouping history 125 to describe the generated avatar group 127.

At step 390, the grouping application 128 may generate a group profile 124. The group profile 124 may be generated by combining the preference attributes from the user profiles 106 of each member of the avatar group 127 (e.g., by determining the least common preferences from each user profile 106). Alternatively, the group profile 124 may be based on the user profile 106 of a specific member (or of specific members) of the avatar group 127. After step 390, the method 300 terminates.

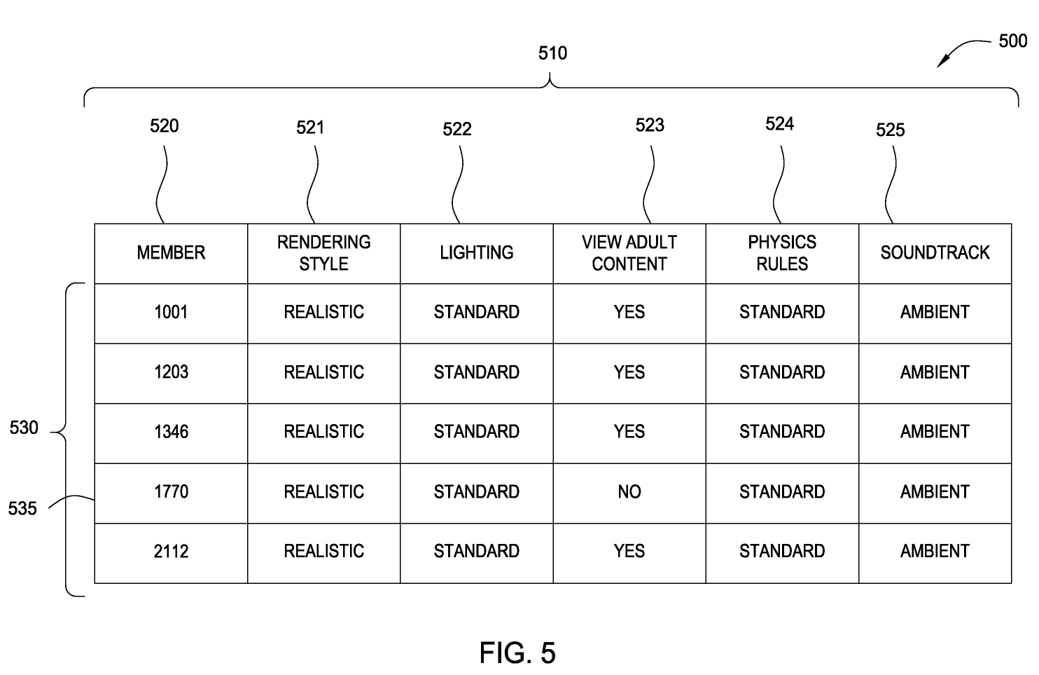

FIG. 5 illustrates an exemplary group profile 500, according to one embodiment of the invention. As shown, group profile 500 may be composed in the form of a data table, with rows 530 representing the users included in the group, and columns 510 representing the preference attributes. More specifically, the “MEMBER” column 520 stores a unique identifier for each member of the group, while the remaining columns 521-525 store values for various attributes used in presenting the virtual world 130. For example, the “SOUNDTRACK” column 525 stores the value “AMBIENT” for each user. This indicates that all users will hear the same soundtrack titled “AMBIENT” while they are part of the group corresponding to the group profile 500. Note that the row 535 includes the preference attributes for the user “1770.” Note also that user “1770” has the value “NO” in the “VIEW ADULT CONTENT” column 523, and that this value is different from the other group members. This difference reflects the fact that the user “1770” has a personal exception to the group profile 500. Such exceptions may allow users to generally participate in a group, while maintaining a personal user preference in specific attributes. Of course, the group profile 500 is provided for the sake of illustration, and is not limiting of the invention. Other embodiments are contemplated. For example, personal exceptions may be stored separately from the group profile, for instance in a user profile 106 included in a client computer 110. In another example, the group profile may be composed in other forms or data structures, such as XML metadata, text files, and the like.

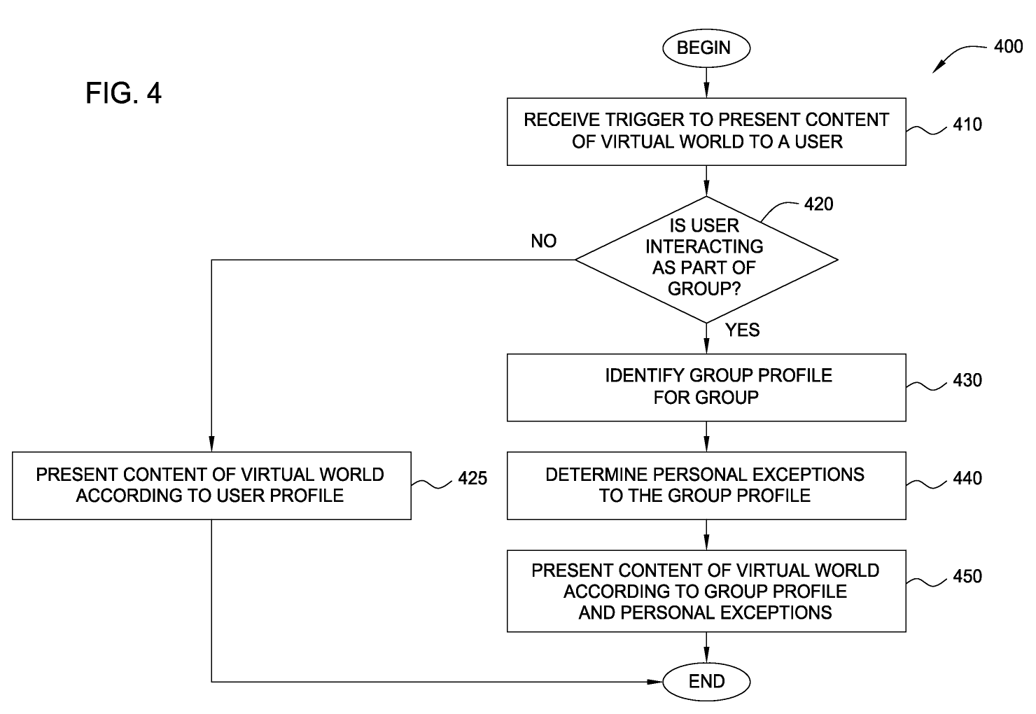

FIG. 4 is a flow diagram illustrating a method 400 for presenting a virtual world to a group of avatars, according to one embodiment of the invention. For the sake of illustration, method 400 is described in conjunction with the system of FIG. 1. However, persons skilled in the art will understand that any system configured to perform the steps of method 400, in any order, is within the scope of the present invention.

The method 400 begins at step 410, when a trigger indicating a need to present content of a virtual world to a user (or users) is received. The trigger may be an action or event occurring within the virtual world 130. For example, an avatar may enter a location included in a virtual world (e.g., store 200 illustrated in FIG. 2). In this case, the act of entering a new location may trigger the presentation of the interior of the store 200 within a visual display (e.g., the user display 200 illustrated in FIG. 2). Alternatively, the received trigger may be a user command (e.g., menu selection, toolbar selection, etc.) indicating that the user wishes to interact with the virtual world 130 (e.g., the user interacts with the kiosk 280 illustrated in FIG. 2).

At step 420, it is determined whether the user is currently interacting with the virtual world 130 as part of a defined group of avatars (i.e., an avatar group 127 determined using the method 300 illustrated in FIG. 3). For example, the grouping application 128 may identify other avatars present within a predefined distance of the user's avatar. Alternatively, the grouping application 128 may identify the N (where N is an integer) avatars closest to the user's avatar. The grouping application 128 may then determine whether the user's avatar and at least one other avatar present in the same location (e.g., within a given distance) are part of an avatar group 127. In one embodiment, the grouping application 128 may be configured to identify a minimum number of avatars that are present in the same location before determining that the user is interacting with the virtual world 130 as part of an avatar group 127. If it is determined at step 420 that the user is not currently interacting with the virtual world 130 as part of an avatar group 127, the method 400 continues at step 425, where the content of the virtual world 130 may be presented to the user according to the user profile 106 (i.e., according to the individual preferences specified by the user in user profile 106). After step 425, the method 400 terminates.

However, if is determined at step 420 that the user is currently interacting with the virtual world 130 as part of an avatar group 127, then the method 400 continues at step 430, where the grouping application 128 may identify a group profile 124 for the avatar group 127. Optionally, if there is no group profile 124 available, the grouping application 128 may then generate a group profile 124 for the avatar group 127. At step 440, the grouping application 128 may determine if there are any personal exceptions to the group profile 124. For example, a user may have specified (e.g., in the user profile 106) a preference to never be presented with content that is offensive to the user's religious beliefs. Thus, the grouping application 128 may present the user with content according to the group profile 124, except for any content that the user has specifically requested to avoid.

At step 450, the content of the virtual world 130 may be presented to the user according to the group profile 124 (i.e., the group preferences determined using step of 390 of the method 300 illustrated in FIG. 3) and any personal exceptions determined at step 440. For example, assume that a group of avatars enters the store 220 shown in FIG. 2, and together examine virtual goods displayed within the store. In the situation that the group of avatars shares a group profile 124, each member of the group will experience the virtual goods in the same way. That is, each user will perceive the virtual goods as having the same visual appearance (e.g., virtual paintings), the same audio characteristics (e.g., virtual recordings or music instruments), the same interactive behavior (e.g., virtual vehicles), and the like. Further, if the group profile 124 specifies that some content should not be presented (e.g., offensive content, sexually explicit content, profanities, etc.), such content will not be presented to the members of the group. Thus, if the users represented by the avatars discuss a particular virtual good included in the store 220, there is a reduced probability of confusion due to each user experiencing the virtual world 130 in a different way.

In some situations, a member of the group may wish to specify a personal exception to the group profile 124. That is, a user may specify to not be presented with some content that is presented to the rest of the group, or that the user is presented with the content in a different manner than the rest of the group. For example, one user may have specified (e.g., in the user profile 106) to never be shown sexually explicit content. In this situation, that user may view all virtual goods in the store 220 according to the group profile 124, except for any virtual goods that may be considered to be sexually explicit. In one embodiment, a member of a group that is currently experiencing the virtual world 130 under a personal exception (i.e., not identically to the other members of the group) may be identified to the other members. For example, an avatar of a user utilizing a personal exception may be associated to a graphical indicator (e.g., an icon, a label, a color, etc.). Optionally, the user having a personal exception may be able to hide such an indicator from other members of the group. After step 450, the method 400 terminates.

Of course, methods 300 and 400 are provided for illustrative purposes only, and are not limiting of the invention. It is contemplated that the steps of methods 300 and 400 may be modified to incorporate other steps for grouping avatars or presenting content of a virtual world. Such modifications may be made to suit particular situations, and are thus contemplated to be in the scope of the invention.

While the foregoing is directed to embodiments of the present invention, other and further embodiments of the invention may be devised without departing from the basic scope thereof, and the scope thereof is determined by the claims that follow.

What is claimed is:

1. A computer-implemented method, comprising:
receiving one or more characteristics of a plurality of avatars within a virtual world;
determining, on the basis of the one or more characteristics, a group of avatars selected from the plurality of avatars;
determining, based on personal preferences of members of the group of avatars, a shared set of preferences defining the interactions of the members of the group of avatars with the virtual world; and
generating a group profile storing the common set of preferences.

2. The computer-implemented method of claim 1, further comprising presenting the content of the virtual world to the plurality of avatars according to the shared set of preferences specified in the group profile.

3. The computer-implemented method of claim 1, wherein the one or more characteristics comprise interactions between the plurality of avatars.

4. The computer-implemented method of claim 1, wherein the one or more characteristics comprise locations and movements of the plurality of avatars.

5. The computer-implemented method of claim 1, wherein the one or more characteristics comprise past instances of the plurality of avatars being included in other groups of avatars.

6. The computer-implemented method of claim 1, wherein the one or more characteristics comprise content included in viewports of the plurality of avatars.

7. The computer-implemented method of claim 1, wherein the one or more characteristics comprise a predefined list of friends of each of the plurality of avatars.

8. The computer-implemented method of claim 1, wherein determining the shared set of preferences comprises determining one or more personal preferences shared in common by all the members of the group.

9. The computer-implemented method of claim 1, wherein determining the shared set of preferences comprises determining personal preferences of a designated member of the group.

10. The computer-implemented method of claim 1, further comprising, after determining the group of avatars:
notifying each member of the group of avatars that the member is to be included in the group of avatars;
prompting each member for approval of being included in the group of avatars; and
upon receiving an indication of disapproval from a member, excluding the member from the group of avatars.

11. A computer-readable storage medium containing a program, which when executed on a processor performs an operation, the operation comprising:
receiving one or more characteristics of a plurality of avatars within a virtual world;
determining, on the basis of the one or more characteristics, a group of avatars selected from the plurality of avatars;
determining, based on personal preferences of members of the group of avatars, a shared set of preferences defining the interactions of the members of the group of avatars with the virtual world; and
generating a group profile storing the common set of preferences.

12. The computer-readable storage medium of claim 11, further comprising presenting the content of the virtual world to the plurality of avatars according to the shared set of preferences specified in the group profile.

13. The computer-readable storage medium of claim 11, wherein the one or more characteristics comprise interactions between the plurality of avatars.

14. The computer-readable storage medium of claim 11, wherein the one or more characteristics comprise locations and movements of the plurality of avatars.

15. The computer-readable storage medium of claim 11, wherein the one or more characteristics comprise past instances of the plurality of avatars being included in other groups of avatars.

16. The computer-readable storage medium of claim 11, wherein the one or more characteristics comprise content included in viewports of the plurality of avatars.

17. The computer-readable storage medium of claim 11, wherein the one or more characteristics comprise a predefined list of friends of each of the plurality of avatars.

18. The computer-readable storage medium of claim 11, wherein determining the shared set of preferences comprises determining one or more personal preferences shared in common by all the members of the group.

19. The computer-readable storage medium of claim 11, wherein determining the shared set of preferences comprises determining personal preferences of a designated member of the group.

20. A system, comprising:
a processor; and
a memory containing a program, which when executed by the processor is configured to perform an operation, the operation comprising the steps of:
receiving one or more characteristics of a plurality of avatars within a virtual world;
determining, on the basis of the one or more characteristics, a group of avatars selected from the plurality of avatars;
determining, based on personal preferences of members of the group of avatars, a shared set of preferences defining the interactions of the members of the group of avatars with the virtual world; and
generating a group profile storing the common set of preferences.
